(19) United States
(12) Patent Application Publication
(10) Pub. No.: US 2019/0042657 A1
(43) Pub. Date: Feb. 7, 2019

(54) CONCIERGE SYSTEM, CONCIERGE METHOD, AND CONCIERGE PROGRAM

(71) Applicant: OPTiM Corporation, Saga-shi (JP)

(72) Inventor: Shunji SUGAYA, Tokyo (JP)

(21) Appl. No.: 16/078,709

(22) PCT Filed: Apr. 26, 2016
(86) PCT No.: PCT/JP2016/062978

§ 371 Date: Aug. 22, 2018

(51) Int. Cl. G06F 17/30

(52) U.S. Cl. CPC G06F 17/30867; G06F 17/30876

(57) ABSTRACT

The present invention provides a concierge system, a concierge method, and a concierge program that provide information most appropriate for a user based on the weather on a certain day. The concierge system 1 provides customized information to a user based on weather information, including: a weather information acquisition module 14 that acquires the weather information from an external weather-related system 30; a physical condition information acquisition module 15 that acquires physical condition information from an external physical condition-related system 40; a related information data DB 17 that stores related information associating the weather information for a predetermined period that the weather information acquisition module 14 acquires with the physical condition information on a user for the predetermined period that the physical condition information acquisition module 15 acquires; and a user individual information providing module 18 that provides information appropriate for the user based on the weather information on a certain day, the appropriate information being computed based on the stored related information.

### TECHNICAL FIELD

The present invention relates to a concierge system that provides customized information to a user based on weather information.

### BACKGROUND ART

In the past, information on the weather has been distributed from various sources because people's behavior varies according to the weather.

For example, an information distribution system is proposed, in which the user terminal transmitter transmits a distribution message to an information distribution device together with a distribution condition including a preferred distribution time and the weather at this time, and the information distribution device acquires weather forecast information at the preferred distribution time from a weather information providing system and transmits the distribution message to a user terminal receiver at the preferred distribution time only if the weather forecast information corresponds to the weather under the distribution condition (refer to Patent Document 1). The device of Patent Document 1 is capable to automatically distribute information based on the weather.

### CITATION LIST

### Patent Literature

Patent Document 1: JP 2008-209983A

### SUMMARY OF INVENTION

The behavior according to the weather (e.g., temperature, weather, humidity) varies depending on a user. For example, some users may feel hot at a temperature of 20° C., but others may feel cold at this temperature depending on physical conditions. In this case, ones who feel hot preferably wear light clothes, but others who feel cold preferably wear heavy clothes.

However, the information distribution system of Patent Document 1 is not capable to provide information (e.g., clothing, skin care) most appropriate for a user (who operates a user terminal receiver) in the weather (e.g., temperature, weather, humidity) on a certain day because the distributor distributes preferred information.

In view of the above-mentioned problems, an objective of the present invention is to provide a concierge system, a concierge method, and a concierge program that provide information most appropriate for a user in the weather on a certain day.

The first aspect of the present invention provides a concierge system that provides customized information to a user based on weather information, including:

a weather information acquisition unit that acquires the weather information from an external weather-related system;

a physical condition information acquisition unit that acquires physical condition information from an external physical condition-related system;

a memory unit that stores related information associating the weather information for a predetermined period that the weather information acquisition unit acquires with the physical condition information of the user for the predetermined period that the physical condition information acquisition unit acquires; and

an information providing unit that provides information appropriate for the user based on the weather information on a certain day, the appropriate information being computed based on the stored related information.

The first aspect of the present invention is capable to store related information associating the weather information for a predetermined period with the physical condition information of the user for the predetermined period and provide information appropriate for the user based on the weather information on a certain day, the appropriate information being computed based on the related information. Accordingly, for example, the past weather information (e.g., temperature, weather, humidity) can be associated and accumulated with the physical condition information of the user on the day, and then information most appropriate for the user that corresponds to the weather can be computed based on the accumulated information. The use of such most appropriate information can avoid the user from, for example, sweating too much because it is too hot, catching a cold because it is too cold, and having dry skin or clammy skin. Therefore, the concierge system can provide information most appropriate for a user in the weather on a certain day.

The first aspect of the present invention is the category of a system, but the categories of a method and a program have similar functions and effects.

The second aspect of the present invention provides the concierge system according to the first aspect of the present invention, in which the information appropriate for a user that the information providing unit provides is information on clothing protecting from catching a cold.

The second aspect of the present invention is capable to provide the information on clothing protecting from catching a cold that is most appropriate for a user in the weather on a certain day based on the related information.

The third aspect of the present invention provides the concierge system according to the first aspect of the present invention, in which the information appropriate for a user that the information providing unit provides is information on skin care preventing dry skin.

The third aspect of the present invention is capable to provide the information on skin care preventing dry skin that is most appropriate for a user in the weather on a certain day based on the related information.

The fourth aspect of the present invention provides the concierge system according to the first aspect of the present invention, in which the information appropriate for a user that the information providing unit provides is information on a pollen allergy measure to have a comfortable time.

The fourth aspect of the present invention is capable to provide the information on a pollen allergy measure to have a comfortable time that is most appropriate for a user in the weather on a certain day based on the related information.

The present invention can provide a concierge system, a concierge method, and a concierge program that provide information most appropriate for a user based on the weather on a certain day.

### BRIEF DESCRIPTION OF DRAWINGS

FIG. 1 shows an overview of the concierge system 1 according to a preferable embodiment of the present invention.

FIG. 2 shows an overall configuration diagram of the concierge system 1.

FIG. 3 shows a functional block diagram of the concierge system 1 to illustrate the relationship among the functions.

FIG. 4 shows a flow chart of the user individual information providing process that the server 10 performs.

FIG. 5 shows a diagram to illustrate the related information data stored in the related information data DB 17 of the server 10.

FIG. 6 shows a diagram to illustrate the information-to-provide data stored in the information-to-provide data DB 19 of the server 10.

FIG. 7 shows one example of the screen displayed on the input-output unit 24 of the terminal 20, which is an image of the user individual information screen based on user individual information.

### DESCRIPTION OF EMBODIMENTS

Embodiments of the present invention will be described below with reference to the attached drawings. However, these are illustrative only, and the technological scope of the present invention is not limited thereto.

### Overview of Concierge System

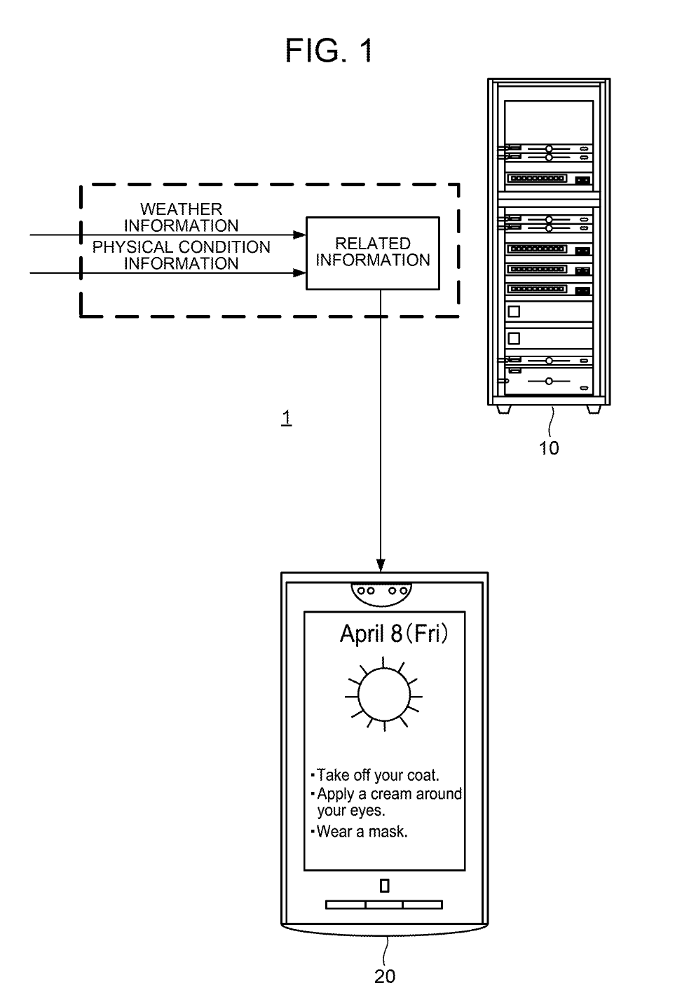

FIG. 1 shows an overview of the concierge system 1 according to a preferable embodiment of the present invention. The overview of the concierge system 1 will be described below with reference to FIG. 1. The concierge system 1 includes a server 10 and a terminal 20.

The concierge system 1 provides information customized for a user based on weather information. Specifically, in the concierge system 1, the server 10 transmits the customized information based on weather information to a terminal 20 that the user operates.

More specifically, the server 10 acquires (receives) weather information from an external weather-related system and user's physical condition information from an external physical condition-related system. In this embodiment, “weather information” includes temperature, weather, and humidity, which may include a realistic value and a forecast value. “Physical condition information” includes a physical condition, a feeling, a skin condition, and the symptom of hay fever.

Then, the server 10 stores related information associating the acquired (received) weather information for a predetermined period (e.g., the past one year) with the physical condition information of the user for the predetermined period and transmits the information appropriate for the user based on the weather information on a certain day computed based on the related information to the terminal 20 of the user.

In this embodiment, “information appropriate for a user” includes clothing protecting from catching a cold (“Take off your coat.” in the example shown in FIG. 1), skin care preventing dry skin (“Apply a cream around your eyes.” in the example shown in FIG. 1), and a pollen allergy measure to have a comfortable time (“Wear a mask.” in the example shown in FIG. 1).

Such a concierge system 1 can provide information most appropriate for a user in the weather on a certain day.

### System Configuration of Concierge System

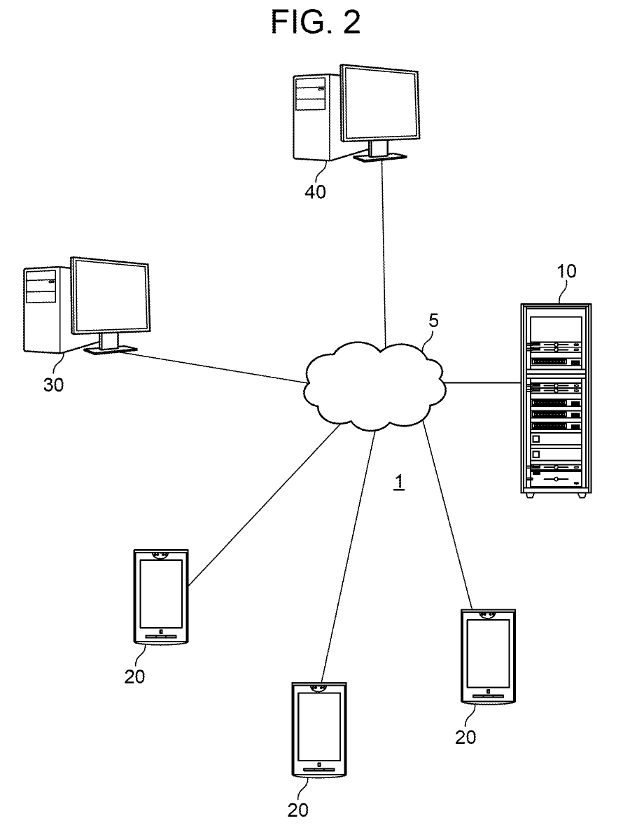

FIG. 2 shows an overall configuration diagram of the concierge system 1. In the concierge system 1, the server 10 and the terminal 20 are communicatively connected with each other through a public line network 5. The server 10 and the terminal 20 are communicatively connected with a weather-related system 30 and a physical condition-related system 40 that exist outside through a public line network 5.

The server 10 may be a general server provided with the functions to be described later. The terminal 20 may be a general information terminal provided with a communication unit, which is an information device provided with the functions to be described later. For example, the terminal 20 may be a portable terminal such as a mobile phone, a smart phone, a net book terminal, a slate terminal, an electronic book terminal, an electronic dictionary terminal, a portable music player, or a portable content recording and reproducing device, or may be a stationary terminal such as a personal computer.

### Functions

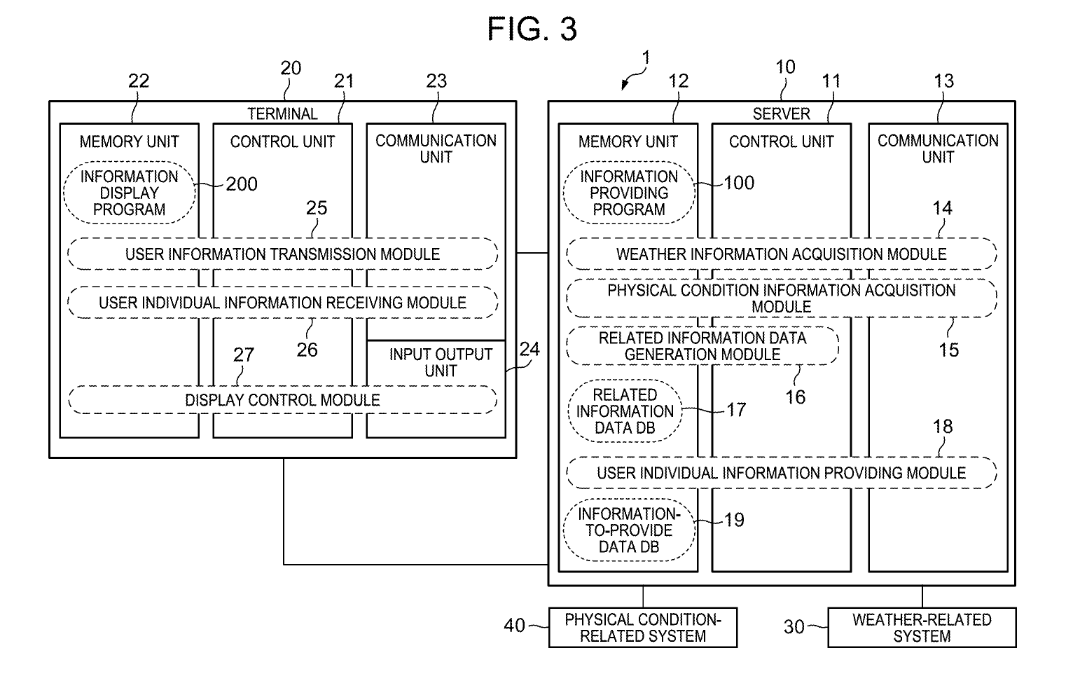

FIG. 3 shows a functional block diagram of the concierge system 1 to illustrate the relationship among the functions.

The server 10 includes a control unit 11 including a central processing unit (hereinafter referred to as “CPU”), a random access memory (hereinafter referred to as “RAM”), and a read only memory (hereinafter referred to as “ROM”); a memory unit 12 including a data storage unit such as a hard disk or a semiconductor memory; and a communication unit 13 including a Wireless Fidelity or Wi-Fi® enabled device complying with, for example, IEEE 802.11, or a wireless device complying with the IMT-2000 standard such as the third or the fourth generation mobile communication system. The memory unit 12 stores data necessary for control of the server 10, such as an information providing program 100, a related information data DB 17, and an information-to-provide data DB 19.

In the server 10, the control unit 11 reads an information providing program 100 to achieve a weather information acquisition module 14, a physical condition information acquisition module 15, and a user individual information providing module 18 in cooperation with the memory unit 12 and the communication unit 13. Furthermore, in the server 10, the control unit 11 reads an information providing program 100 to achieve a related information data generation module 16 in cooperation with the memory unit 12.

The terminal 20 includes a control unit 21 including a CPU, a RAM, and a ROM; a memory unit 22 including a data storage unit; and a communication unit 13 including a Wi-Fi® enabled device complying with, for example, IEEE 802.11 (or may be a wired device) in the same way as the server 10. The terminal 20 also includes an input-output unit 24 including a display unit such as a touch panel or a display unit and an input unit such as a touch panel, a keyboard, or a mouse. The memory unit 22 stores data necessary for control of the terminal 20, such as an information display program 200.

In the terminal 20, the control unit 21 reads an information display program 200 to achieve a user information transmission module 25 and a user individual information receiving module 26 in cooperation with the memory unit 22 and the communication unit 23. Furthermore, in the terminal 20, the control unit 21 reads an information display program 200 to achieve a display control module 27 in cooperation with the memory unit 22 and the input-output unit 24.

### User Individual Information Providing Process

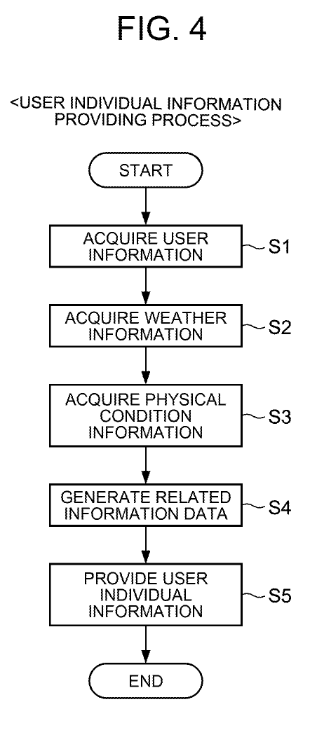

FIG. 4 shows a flow chart of the user individual information providing process that the server 10 performs. The processes performed by the modules of the server 10 are explained below together with this process.

In the step S1, the server 10 receives information that identifies a user (e.g., information that indicates a name, an address, etc.) from the user information transmission module 25 of the terminal 20, assigns a user ID to the user, and stores the information in the memory unit 12.

In the step S2, the weather information acquisition module 14 receives weather information associated with date information from an external weather-related system 30 and stores this information in the memory unit 12.

In the step S3, the physical condition information acquisition module 15 receives the physical condition information on a user to whom a user ID was assigned in the step S1 that is associated with date information from an external physical condition-related system 40 and stores this information in the memory unit 12.

In the step S4, the related information data generation module 16 stores related information associating the weather information for a predetermined period (e.g., the past one year) that the weather information acquisition module 14 received in the step S2 with the physical condition information on a user for the predetermined period that the physical condition information acquisition module 15 acquired in the step S3 in the related information data DB 17.

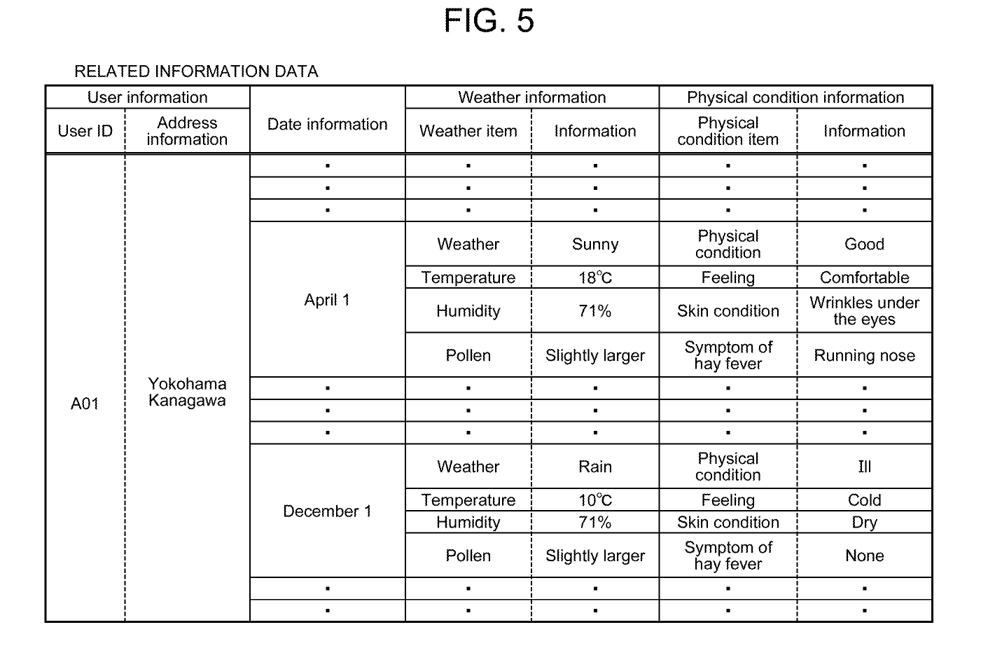

FIG. 5 shows a diagram to illustrate the related information data stored in the related information data DB 17 of the server 10. The related information data includes user information associated with date information associated with weather information and physical condition information. The user information includes the ID and the address information of a user. The weather information includes information that indicates the weather, the temperature, the humidity, and the amount of pollen as weather items on the date that the associated date information indicates. The physical condition information includes information that indicates the physical condition, the feeling, and the skin condition as physical condition items on the date that the associated date information indicates.

In this embodiment, the physical condition items of the physical condition information are associated with the respective weather items of the weather information but not limited thereto. One physical condition item may be associated with two or more weather items, and two or more physical condition items may be associated with one or more weather items.

Reverting to FIG. 4, in the step S5, the user individual information providing module 18 computes information appropriate for the user in weather information on a certain day based on the related information data DB 17 that the related information data generation module 16 stored in the step S4 and transmits this information to the terminal 20.

Specifically, the user individual information providing module 18 refers to the related information data DB 17 (refer to FIG. 5), searches information that is consistent with or approximate to weather information on the certain day that the weather information acquisition module 14 receives, within a predetermined range (e.g., March 1 to May 1 (last year) if the certain day is April 1) including a certain day (e.g., the current day or the next day), and extracts physical condition information associated with this weather information.

Accordingly, including date information in the related information data DB 17 and limiting the search range when the user individual information providing module 18 computes information appropriate for the user in a certain day to a predetermined range including the date of the certain day can improve the retrieval precision and reduce the processing load of the control unit 11 on the search. If the user individual information providing module 18 does not limit the search range to a predetermined range including the date of a certain day when performing the search, the related information data DB 17 should not include date information.

Then, the user individual information providing module 18 refers to the information-to-provide data associating information to provide with physical condition information, extracts the information to provide associated with the extracted physical condition information, and transmits the extracted information to provide to the terminal 20.

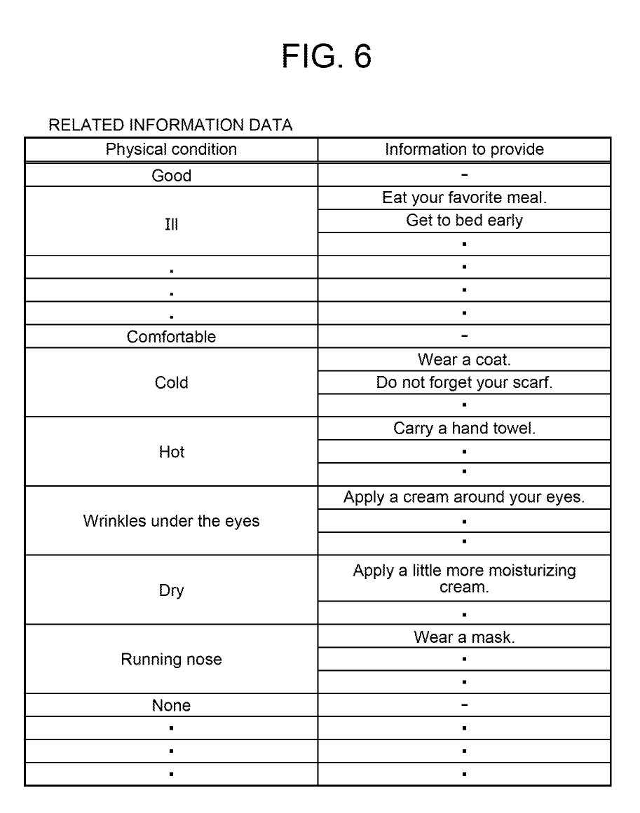

FIG. 6 shows a diagram to illustrate the information-to-provide data stored in the information-to-provide data DB 19 of the server 10. The information-to-provide data associate one kind of physical condition information with two or more kinds of physical condition information.

The user individual information providing module 18 determines one kind of information to provide from among two or more kinds of information to provide associated with certain physical condition information. In this case, the user individual information providing module 18 determines one kind of information to provide from among two or more kinds of information to provide based on the extraction process, the user information, the date information, etc. This diversifies information provided to a user. The information-to-provide data associates one kind of physical condition information with one kind of physical condition information.

Then, the user individual information providing module 18 transmits user individual information that is the information appropriate for the user, including the weather information and the determined information to provide to the terminal 20. In the terminal 20, the user individual information receiving module 26 receives the user individual information transmitted from the server 10, and the display control module 27 displays the user individual information screen based on the user individual information on the input-output unit 24.

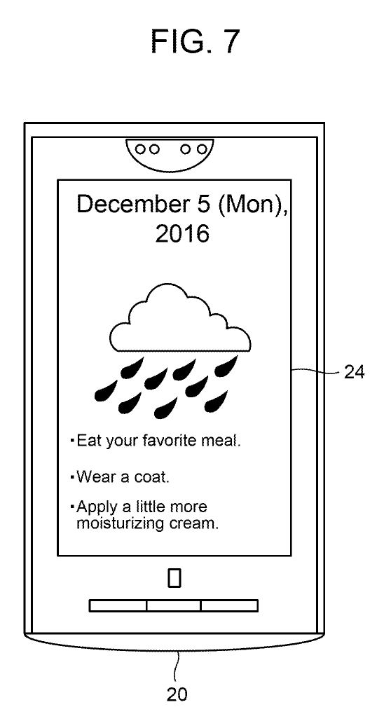

FIG. 7 shows one example of the screen displayed on the input-output unit 24 of the terminal 20, which is an image of the user individual information screen based on user individual information. For example, in the server 10, if the weather information on a certain day (December 5 in the example shown in FIG. 7) when the weather information acquisition module 14 acquired indicates weather: rain, temperature: 10° C., and humidity: 71%, and amount of pollen: slightly larger, the user individual information providing module 18 refers to the related information data DB 17 (refer to FIG. 5), searches information that is consistent with or approximate to weather information on a certain day (December 1 in the example shown in FIG. 5), and extracts physical condition information associated with this weather information (physical condition: ill, feeling: cold, skin condition: dry, and symptom of hay fever: none).

Then, the user individual information providing module 18 refers to the information-to-provide data of the information-to-provide data DB 19 (refer to FIG. 6), determines “Eat your favorite meal.” associated with the physical condition information “ill,” “Wear a coat.” associated with the physical condition information “cold, ” and “Apply a little more moisturizing cream.” associated with the physical condition information “dry” as information to provide based on the extracted physical condition information (physical condition: ill, feeling: cold, skin condition: dry, and symptom of hay fever: none), and transmits the user individual information including this information to provide and weather information to the terminal 20.

Then, in the terminal 20, the user individual information receiving module 26 receives the user individual information transmitted from the server 10, and the display control module 27 displays the user individual information screen based on the user individual information as shown in FIG. 7 on the input-output unit 24.

To achieve the means and the functions that are described above, a computer (including a CPU, an information processor, and various terminals) reads and executes a predetermined program. For example, the program is provided in the form recorded in a computer-readable medium such as a flexible disk, CD (e.g., CD-ROM), or DVD (e.g., DVD-ROM, DVD-RAM). In this case, a computer reads a program from the record medium, forwards and stores the program to and in an internal or an external storage, and executes it. The program may be previously recorded in, for example, a storage (record medium) such as a magnetic disk, an optical disk, or a magnetic optical disk and provided from the storage to a computer through a communication line.

The embodiments of the present invention are described above. However, the present invention is not limited to the above-mentioned embodiments. The effect described in the embodiments of the present invention is only the most preferable effect produced from the present invention. The effects of the present invention are not limited to those described in the embodiments of the present invention.

### REFERENCE SIGNS LIST

1 Concierge system
30 Weather-related system
14 Weather information acquisition module
15 Physical condition information acquisition module
17 Related information data DB
18 User individual information providing module

1. A concierge system that provides customized information to a user based on weather information, comprising:
a weather information acquisition unit that acquires the weather information from an external weather-related system;
a physical condition information acquisition unit that acquires physical condition information from an external physical condition-related system;
a memory unit that stores related information associating the weather information for a predetermined period that the weather information acquisition unit acquires with the physical condition information of the user for the predetermined period that the physical condition information acquisition unit acquires and information-to-provide data associating information to provide with the physical condition information; and
an information providing unit that refers to the stored related information data, searches information that is consistent with or approximate to the weather information on a certain day, extracts the physical condition information associated with the weather information, refers to the information-to-provide data, extracts the information to provide associated with the extracted physical condition information, and provides the extracted information to provide.

2. The concierge system according to claim 1, wherein the information appropriate for a user that the information providing unit provides is information on clothing protecting from catching a cold.

3. The concierge system according to claim 1, wherein the information appropriate for a user that the information providing unit provides is information on skin care preventing dry skin.

4. The concierge system according to claim 1, wherein the information appropriate for a user that the information providing unit provides is information on a pollen allergy measure to have a comfortable time.

5. A method executed by a concierge system that provides customized information to a user based on weather information, comprising the steps of:
acquiring the weather information from an external weather-related system;
acquiring physical condition information from an external physical condition-related system;
storing related information associating the weather information for a predetermined period acquired in the step of acquiring the weather information with the physical condition information of the user for the predetermined period acquired in the step of the physical condition information and information-to-provide data associating information to provide with the physical condition information; and
referring to the stored related information data, searching information that is consistent with or approximate to the weather information on a certain day, extracting the physical condition information associated with the weather information, referring to the information-to-provide data, extracting the information to provide associated with the extracted physical condition information, and providing the extracted information to provide.

6. A program for causing a computer that controls a concierge system that provides customized information to a user based on weather information to function as:
a weather information acquisition unit that acquires the weather information from an external weather-related system;
a physical condition information acquisition unit that acquires physical condition information from an external physical condition-related system;
a memory unit that stores related information associating the weather information for a predetermined period that the weather information acquisition unit acquires with the physical condition information of the user for the predetermined period that the physical condition information acquisition unit acquires and information-to-provide data associating information to provide with the physical condition information; and
an information providing unit that refers to the stored related information data, searches information that is consistent with or approximate to the weather information on a certain day, extracts the physical condition information associated with the weather information, refers to the information-to-provide data, extracts the information to provide associated with the extracted physical condition information, and provides the extracted information to provide.
